(19) United States
(12) Patent Application Publication
(10) Pub. No.: US 2004/0112204 A1
(43) Pub. Date: Jun. 17, 2004

(54) Device for monitoring a soundboard-type electronic musical instrument

(76) Inventor: Gilbert Javelle, Saint Etienne (FR)

Correspondence Address: YOUNG & THOMPSON, 745 SOUTH 23RD STREET 2ND FLOOR, ARLINGTON, VA, 22202

(21) Appl. No.: 10/468,212

(22) PCT Filed: Feb. 18, 2002
(86) PCT No.: PCT/FR02/00620

(30) Foreign Application Priority Data
Feb. 16, 2001 (FR) 01/02432

(51) Int. Cl. G10H 7/00

(52) U.S. Cl. 84/645

(57) ABSTRACT

The invention concerns a device comprising a glove (G) adapted to be worn on the user's hand. The glove is equipped with several sensors connected to a printed circuit connected to an electronic interface (IE) designed to format and transform electronic signals into MIDI signals, said interface being connected to the soundboard (BS). The glove (G) is designed to interact with a tabor (T) held in the user's other hand. The tabor surface (T) acts on the sensors. The invention is useful for reducing sound nuisance of certain concert instruments and enhance scenic effect.

The invention relates to the technical sector of musical instruments and ensembles.

If consideration is given to respect of the environment with regard to sound nuisance, it would appear that many groups of musicians, who play electrical instruments more particularly, increasingly encounter difficulty in playing in public or private places such as bars. In fact these various electrical instruments: guitars, basses, keyboards, drum kits, etc., generate relatively high noise. This is particularly the case for the drum kit which, moreover, can only be managed with great difficulty in terms of acoustics. In fact, although it is possible to reduce the power of a guitar or of a keyboard, by means of a simple potentiometer, this is not the case with a drum kit.

Taking account of this problem and of the regulations in force regarding sound nuisance, many musicians are consequently using “acoustic” guitars and traditional instruments and voices, amplified by small “amps”. Although it can be considered that the problem relating to noise is solved under these conditions, it is however to the detriment of the musical rhythm provided by a drum kit.

For this reason the use of rhythm boxes pre-programmed for each piece of music has been proposed. These rhythm boxes have the advantage of producing sounds very similar to those of genuine drum kits, with the possibility of adjusting their general volume at will. However, by definition these boxes impose a rhythm to which the musicians must adapt. In other words, the musicians are not totally free to adapt their repertoire to the preference of their audience for example.

Finally, so-called “electronic” drum kits are known. These require a large amount of space and the virtual necessity of calling upon a real drummer to play them.

The documents DE 40 15 323 A1, GB 2 221 557 A, GB 2 231 191 A, EP 0 322 825 A2, U.S. Pat. No. 4,920,848 A describe gloves equipped with sensors for controlling sounds or rhythms according to the movements of the hand. DE 35 18 810 A1 describes the use of two such gloves, one on each hand, for striking an influence surface in the form of a table. When a finger hits the surface, the contact provided on the finger of the glove is influenced and triggers a musical event. This device is reliable but it is bulky and its use results in a frozen show or scenecraft, the musician being seated in front of the influence surface in the form of a table.

The purpose of the invention is to overcome these drawbacks in a simple, reliable, efficient and rational manner.

The problem that the invention proposes to solve is to be able to control a sound box of the rhythm box, keyboard, sampler, etc. type with the possibility of acting in real time on the rhythm and adapting the latter to the music.

Another problem that the invention proposes to solve is to propose a system requiring minimal space.

Yet another problem is to propose a system that is particularly attractive from the scenecraft point of view, that is to say from the point of view of the visual spectacle able to be offered to the spectator.

In order to solve these problems, a device has been designed and developed for controlling an electronic musical instrument, this device comprising a glove or similar capable of being worn on a user's first hand and comprising several sensors on the fingers on the palm side and possibly on the palm itself, said sensors being connected at least indirectly to an electronic interface capable of formatting and converting electrical signals into standardized signals such as “MIDI” signals, said interface being connected to the electronic musical instrument; and an instrument of the tabor type having at least one contact area intended to influence the sensors of the glove, characterized in that the tabor is adapted to be held in the user's second hand.

Without by so doing departing from the scope of the invention, the sensor or sensors may be mounted on types of supports other than a glove and capable of being worn on the user's hand.

In order to solve the problem of being able to create different sounds directly with the hand, the sensors are arranged at the ends of the fingers in question on the palm facing side and on the palm itself.

In order to solve the problem of being able visually to check which sensor or sensors are activated, these sensors are coupled with luminous indication means in the form, for example, of light-emitting diodes.

In order to solve the problem of ensuring the formatting and conversion of the electrical signals into “MIDI” signals, the electronic interface comprises analogue gates contained in integrated circuits of the CD4066 type, each said gate being connected to a desired musical note.

In order to solve the problem of creating musical sounds at will, the sound box consists of an electronic instrument equipped with a “MIDI” connector for allocating a sound or the triggering of a sequence for each sensor, the output of the said sound box being connected to a sound system. Preferably, the output of the box is connected to the sound system via the electronic interface, in which the sound volume is adjusted under the control of a potentiometer provided on the tabor.

In one embodiment, in order to make the sensors particularly sensitive to the touch, the electronic interface is coupled with an instrument of the tabor type having at least one metal area intended to be acted upon by one or more sensors of the glove, said metal area being connected to the positive pole of a power supply. In this case, and in the following text, the word “coupled” signifies “connected in order to receive a command from”.

In order to solve the problem of obtaining pre-recorded sounds, the instrument of the tabor type is equipped with control devices such as switches and/or potentiometers for selecting and/or modifying sounds. This version of the invention is particularly ergonomic. At the same time that he strikes the tabor using his first gloved hand, the user selects the sounds, sound levels, etc., using the fingers of his hand holding the tabor, or by striking his body with one side of the tabor where control devices are located, in particular a push-button.

The electronic interface may also be coupled to a pedal for feeding or not feeding at least one analogue gate at will.

The invention is described below in greater detail with reference to the appended figures in which:

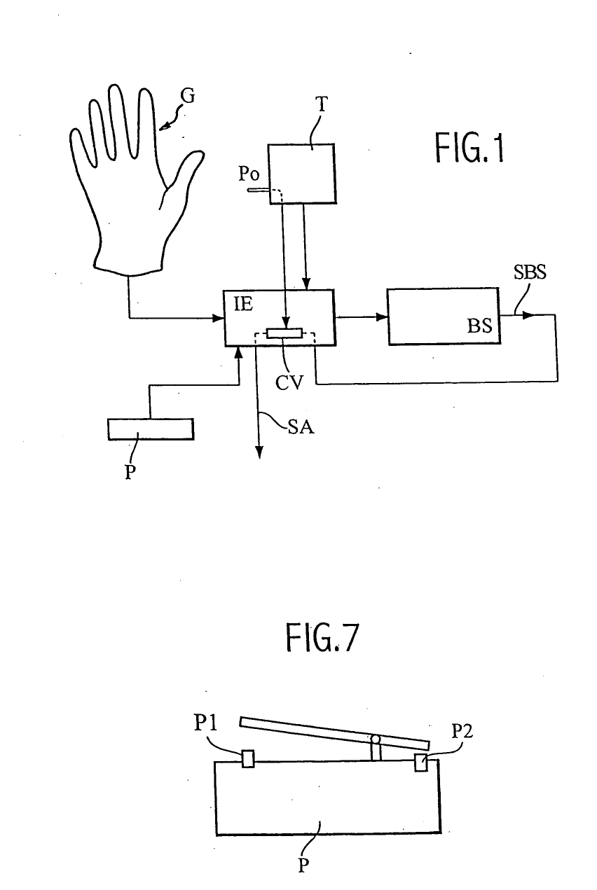

FIG. 1 is a block diagram of the functional principle of the device according to the invention;

FIG. 2 is a top view of the glove according to the invention;

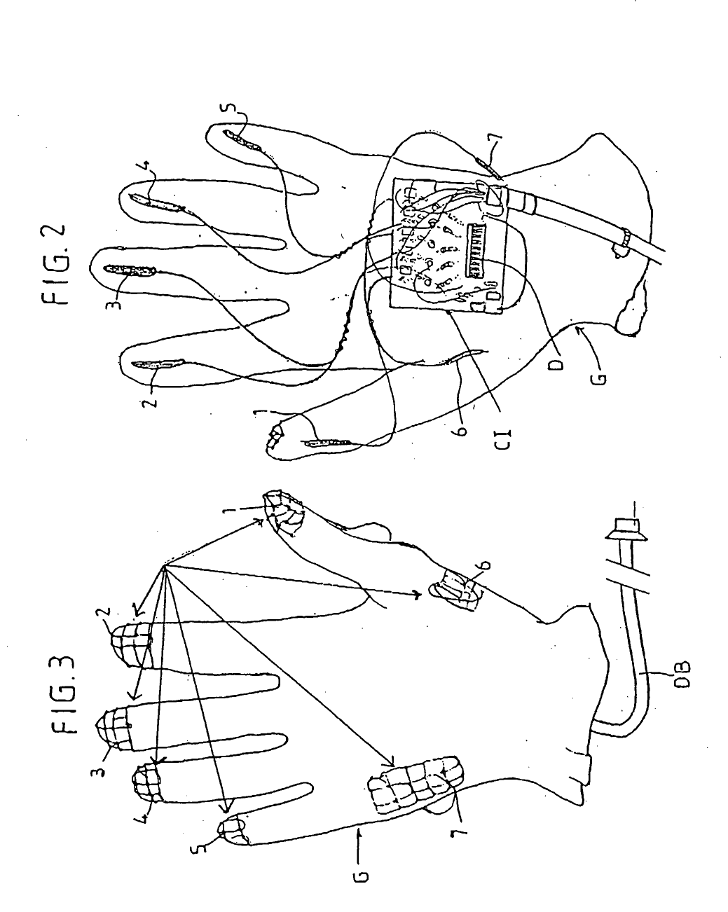

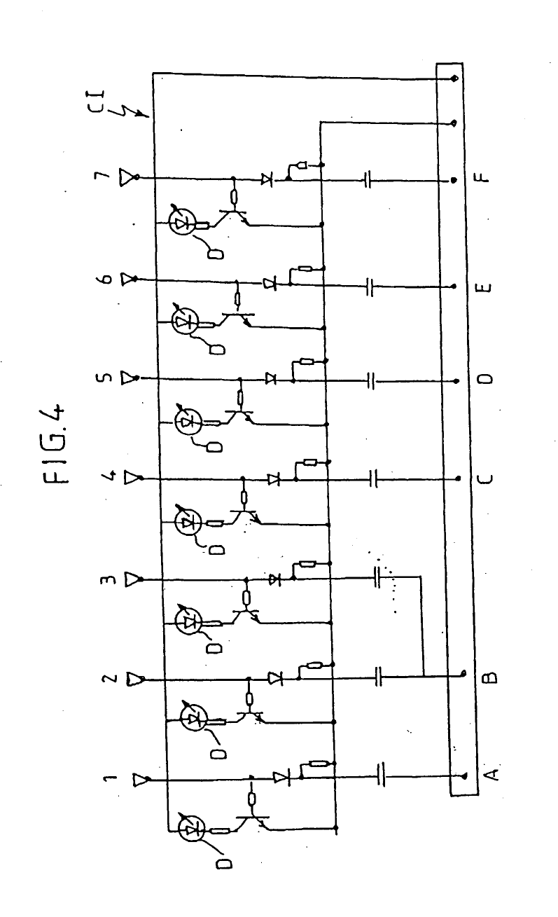

FIG. 3 is a view of the glove seen from the palm side;

FIG. 4 is an example embodiment of the printed circuit that the glove has;

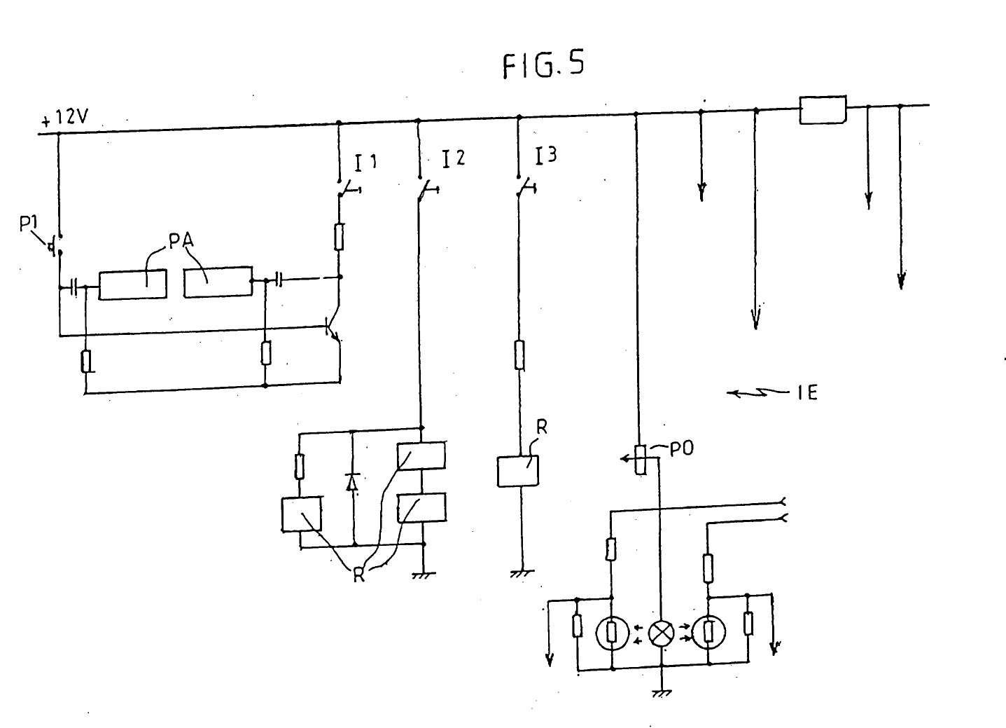

FIG. 5 is a block diagram of the electronic interface;

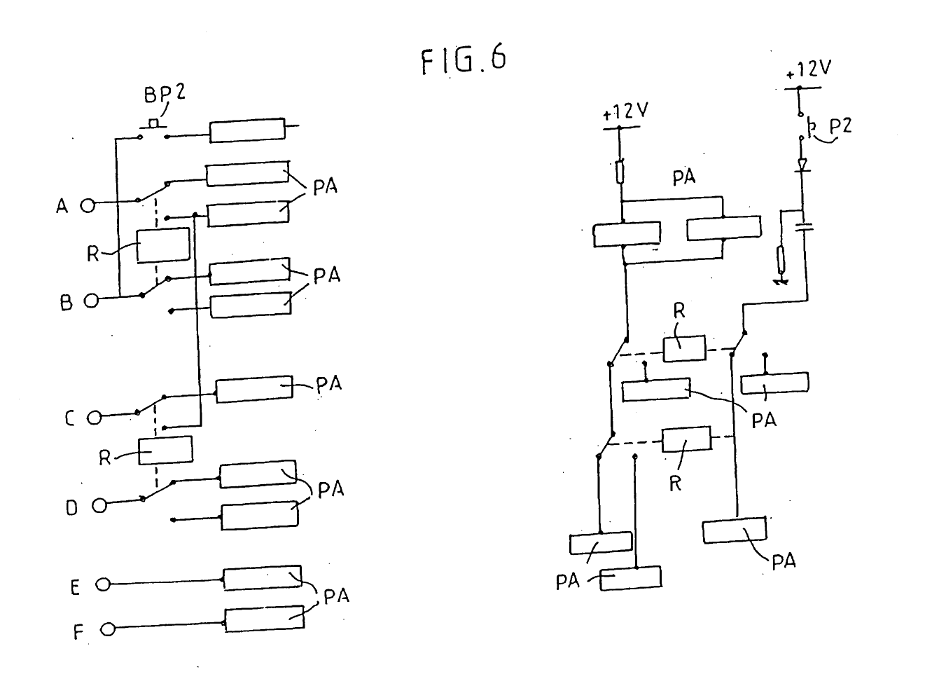

FIG. 6 is a block diagram of the analogue gates;

FIG. 7 is a view, of purely diagrammatic nature, of an embodiment of a control pedal, capable of controlling the electronic interface;

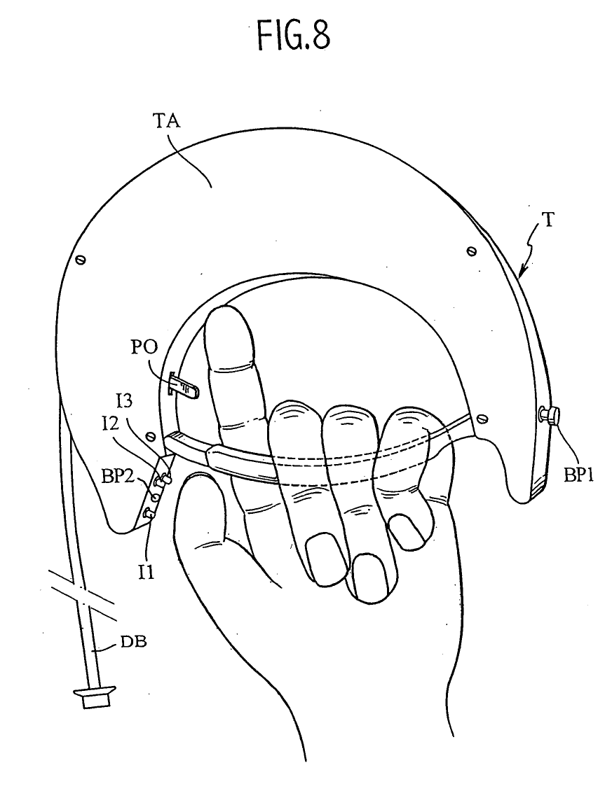

FIG. 8 shows an example embodiment of an instrument of the tabor type intended to be acted upon by the sensor or sensors.

As shown in the block diagram of FIG. 1, the control device comprises at least one glove (G) capable of being worn on the user's hand. This glove (G) is made from any material that is known and appropriate and is not a conductor of electricity.

According to an important feature (see FIGS. 2 and 3),the glove (G) is equipped with several sensors (1, 2, 3, 4, 5, 6, 7) connected to a printed circuit (CI). The sensors may possibly be mounted on types of supports other than a glove and capable of being worn on the user's hand.

The integrated circuit of the glove is connected to an electronic interface (IE) capable of formatting and converting electrical signals into “MIDI” signals. It is recalled that the term “MIDI” is an expression perfectly known, to those skilled in the art, in the field of electronic instruments and signifies “Musical Interface Digital Instrument” corresponding to an international standard for sending digital codes allowing all types of electronic instruments connected with each other by a connector to exchange different types of information (musical notes, tempo, start, stop, etc).

The electronic interface (IE) is therefore connected to the MIDI connector of a sound box (BS) controlled by means of the glove, as will be described in the continuation of the description. This sound box (BS) can be constituted by all types of electronic instruments equipped with a MIDI connector. Among these instruments may be mentioned, in a way that is in no way restrictive, expanders, rhythm boxes, samplers, keyboards, etc.

The various sensors (1, 2, 3, 4, 5, 6, 7) are arranged at the ends of the fingers in question on the palm side and also on the palm itself. For example, sensor (1) corresponds to the thumb, sensor 2 to the index finger, sensor (3) to the middle finger, sensor (4) to the ring finger, sensor (5) to the little finger and sensor (6) to the part of the palm situated next to the little finger. The various sensors consist, for example, of metal plates connected to the integrated circuit (CI) which can be fixed to the top of the glove or can be integrated inside the latter.

Similarly, the fixing of the sensors (1, 2, 3, 4, 5, 6, 7) at the previously mentioned locations can be carried out by any known and appropriate means.

The production of the sensors in the form of metal plates must not be considered as limitative. Preferably, all types of dynamic sensors that are sensitive to touch will be used. Advantageously, in order to indicate the activation or non-activation of the various sensors (1, 2, 3, 4, 5, 6, 7), each of them is mounted in combination with luminous indication means consisting, for example, of light emitting diodes (D).

In the electrical circuit diagram given in FIG. 4 showing an example embodiment of the printed circuit (CI) of the glove, the references (A, B, C, D, E and F) refer to the various outputs corresponding to the various sensors (1, 2, 3, 4, 5 ,6 ,7), it being noted that the sensors (2 and 3) feed a common output (B).

The connection between the printed circuit (CI), particularly with respect to the various outputs (A, B, C, D, E, F) and the corresponding inputs of the electronic interface (IE), is carried out by any type of connector (DB).

The electronic interface (IE) comprises, for each input (A, B, C, D, E, F), that is to say for each electrical contact corresponding to a desired note, analogue gates contained in an integrated circuit of the CD4066 type for example. The reference (PA) denotes these various gates. FIG. 6 shows an example, that is in no way limitative, of the electrical circuit of these analogue gates. (R) denotes the various control relays. The various analogue gates are therefore controlled by the sensors (1, 2, 3, 4, 5, 6, 7) of the glove.

The electronic interface (IE) is coupled with an instrument of the tabor type (T) having at least one metal area (TA) intended to be acted upon by all or some of the various sensors (1, 2, 3, 4, 5, 6, 7) with which the glove (G) is equipped. This metal area is connected to the positive pole of a power supply, a 12 volt one in particular.

This tabor (T), by means of its metal area (TA), increases the sensitivity of the sensors in order to control the corresponding analogue gates instantaneously. The tabor (T) can furthermore be equipped with switches and/or potentiometers in order to select and/or modify the sounds. For example, the tabor (T) is equipped with switches and/or with push-buttons (I1, I2, I3) (BP1, BP2), and possibly with a potentiometer (PO) for controlling the volume. Certain elements can be accessible with the thumb or index finger of the hand holding the tabor, or in the case of a push-button such as (BP1), when the tabor is struck against a part of the player's body, for example the thigh, in such a way as to push in the button (BP1).

The potentiometer (PO) of the tabor (T) is connected to the interface (IE). The output (SBS) of the sound box (BS) is connected to an audio output (SA) via the interface (IE) in which the sound volume is adjusted according to the setting of the potentiometer (PO).

It should also be noted that the device can make use of a pedal (P) capable of occupying two positions (P1 and P2). In the same way as the tabor (T), the pedal (P) is coupled with the electronic interface (IE) in order to feed or not to feed at least one analogue gate, at will.

By way of illustration, that is in no way limitative, the functions that some elements of the device can perform are described below, considering the sensors (1, 2, 3, 4, 5, 6, 7) of the glove (G), the tabor (T) and the pedal (P), in order to control the sound box (BS) at will via the electronic interface (IE).

The switch (I1) makes it possible to select either a drum kit or a percussion kit or, more generally, to activate the various analogue gates in order to obtain different sounds.

Thus, considering the instruments of the drum kit and the percussion instruments, the sensor (1), corresponding to the thumb, can control a bass drum or bongo.

The sensors (2, 3) corresponding to the index finger and the middle finger, can control a side drum and another bongo.

The sensor (4) corresponding to the ring finger, can control a tom-tom 1 and another bongo.

The sensor (5), corresponding to the little finger, can control a “crash” cymbal and a bongo.

The sensor (6), corresponding to the palm, can control a tom-tom 2.

The sensor (7), corresponding to the other palm, can control a “splash” cymbal.

The pedal in position (P1) can control a Charleston cymbal and a stacker or a “Ride” cymbal. The position (P2) of this pedal can control a drum kit of the open Charleston type and a tabla.

The push-button (BP1) can control the tabor directly. It should be noted that the switch (I2) switches the pedal between the two modes (P1) and (P2). According to the mode (P1), the sound is triggered only when the pedal is pressed, whereas, according to the mode (P2), the sound is triggered when the pedal is pressed and when it is released.

The switch (I3) selects the sound allocated to the pedal.

The push-button (BP2) makes it possible to trigger another sound that adds to the one obtained by the sensors (2) and (3) when the latter are acted upon.

It is recalled that the “line out” output (SBS) (FIG. 1) of the sound box (BS) is connected to any sound system via a volume control system (CV) coupled to the potentiometer (PO) and accommodated in the interface (IE).

Starting from this basic concept of the device as defined, the latter can of course advantageously be completed or modified by the following devices:

integration of dynamic touch sensors,

control of a “light show” system using an interface,

addition of several drum and percussion kits,

addition of additional sensors.

The interface (IE) can furthermore be accommodated in the tabor (T).

1. A device for controlling an electronic musical instrument, this device comprising a glove or similar capable of being worn on a user's first hand and comprising several sensors (1, 2, 3, 4, 5, 6, 7) arranged on the fingers on the palm side and possibly on the palm itself, said sensors (1, 2, 3, 4, 5, 6,7) being at least indirectly connected to an electronic interface (IE) capable of formatting and converting electrical signals into standardized signals such as “MIDI” signals, said interface (IE) being connected to the electronic musical instrument; and an instrument of the tabor type (T) having at least one contact area (TA) intended to influence the sensors of the glove,
characterized in that the tabor (T) is adapted to be held in the user's second hand.

2. A device according to claim 1, characterized in that the sensors (1, 2, 3, 4, 5, 6, 7) are connected to luminous indication means (D) for indicating their activation.

3. A device according to claim 1, characterized in that the electronic interface (IE) comprises analogue gates (PA) contained in integrated circuits of the CD4066 type, each said gate (PA) being connected to a desired musical note.

4. A device according to claim 1, characterized in that the musical instrument is a sound box (BS) consisting of an electronic instrument equipped with a “MIDI” connector for allocating at least one sound or sequence-triggering for each sensor, the output (SBS) of the said box being intended to be connected, at least indirectly, to a sound system.

5. A device according to claim 1, characterized in that the instrument of the tabor type (T) is equipped with switches and/or potentiometers (I1, I2, I3, BP1, BP2, PO) for selecting and/or modifying sounds.

6. A device according to claim 1, characterized in that the electronic interface (IE) is connected to a pedal (P) for feeding or not feeding at least one analogue gate at will.

7. A device according to claim 1, characterized in that the pedal (P) has two extreme positions (P1 and P2) each connected to at least one analogue gate.

8. A device according to one of claims 1 to 7, characterized in that said sensors are connected to the interface via a printed circuit (CI) carried by the glove.

9. A device according to one of claims 1 to 8, characterized in that the contact area (TA) is a metal area connected to a power supply pole.

10. Device according to one of claims 1 to 9, characterized in that the interface (IE) is installed in the tabor (T).
